(19) United States
(12) Patent Application Publication
(10) Pub. No.: US 2011/0235605 A1
(43) Pub. Date: Sep. 29, 2011

(54) RADIO RESOURCE ALLOCATION METHOD AND DEVICE OF HENB IN EVOLVED PACKET SYSTEM

(75) Inventors: Tae Sun Yeoum, Seoul (KR); Chae Gwon Lim, Seoul (KR); Sung Ho Choi, Suwon-si (KR); Eun Hui Bae, Seoul (KR)

(73) Assignee: SAMSUNG ELECTRONICS CO., LTD., Suwon-city, Gyeonggi-do (KR)

(21) Appl. No.: 13/131,464

(22) PCT Filed: Nov. 24, 2009
(86) PCT No.: PCT/KR09/06925

§ 371 Date: May 26, 2011

(30) Foreign Application Priority Data
Nov. 28, 2008 (KR) 10-2008-0119549

(51) Int. Cl. H04W 72/04

(52) U.S. Cl. 370/329; 370/328

(57) ABSTRACT

A session-adaptive radio resource allocation device and method for an EPS is provided. A resource allocation method for a wireless communication includes transmitting, at a Home evolved Node B (HeNB) received a downlink packet destined to a User Equipment (UE) in idle mode, a paging message including a local indicator to the UE; transmitting a service request message including the local indicator from the UE to a Mobility Management Entity (MME); transmitting a Initial Context Setup (ICS) message including an uplink Tunnel Endpoint Identifier (TEID) from the MME to the HeNB; and establishing a radio bearer for a local breakout session between the HeNB and UE and a radio bearer corresponding to an Evolved Packet System (EPS) bearer context of an internal Serving Gateway/Packet Data Network Gateway (SGW/PGW) of the HeNB using the TEID).

### TECHNICAL FIELD

The present invention relates to Evolved Packet System (EPS) and, in particular, to a session-adaptive radio resource allocation device and method for an EPS.

### BACKGROUND ART

Recent cellular systems provide packet data services, as well as basic voice communication service, through the interoperability with a packet data network. Typically in the wireless communication system such as Wideband Code Division Multiple Access (WCDMA) system supporting data services, the data services are provided through the operator's network such that the data traffics are concentrated to the operator's network.

In case of a WCDMA system providing the subscribers with internet access service, the packet data transmitted by a User Equipment (UE) are delivered to an Internet Protocol (IP) router through a Node B, a Radio Network Controller (RNC), a Serving GPRS Support Node (SGSN), and a Gateway GPRS Support Node (GGSN). In this case, since the user data are routed through a tunnel established between the RNC to the GGSN using a GPRS Tunneling Protocol (GTP) which operates unlike the typical IP routing protocols, IP routers placed on the link between the RNC and GGSN do not know the content of the data. This means that the packet data transmitted by the user must pass across the GGSN, i.e. the operator's IP router, regardless of the location of the Internet server which the user wants to access. However, this IP packet routing method is very inefficient as compared to the normal IP routing method. In such a network structure, the traffic load of the operator's network increases significantly as a number of users of the data service increases.

A home networking service is another example as a packet data service provided in a cellular network system. In Long Term Evolution (LTE) as an evolved 3GPP mobile communication technology, a Home evolved Node B (HeNB) is defined as a femto cell to support LTE air interface, and researches are being conducted to control electric appliances and play audio and video data remotely using a User Equipment (UE) connected to the HeNB. Here, the HeNB can be defined as a femto base station similar to a DSL router and a cable modem to provide cellular coverage in a subscriber's home or small business and provides cellular coverage very small as compared to a macro Node B (macro NB). In the current LTE system, however, the data transmitted to the HeNB must be delivered across the operator's network such that even the local traffic which is not required to leave the current region travels across the operator's network unnecessarily.

As aforementioned, the conventional mobile communication systems supporting IPbased data services deliver even the local traffic through the operator's network, and thus the local traffic delivered through inefficient routing paths increases traffic load unnecessarily from the viewpoint of the operator's network and causes propagation latency of the data.

In order to solve this problem, the HeNB is implemented with a local breakout function to optimize routing of the user traffic within the home network or to the Internet without crossing the operator s network. For this purpose, the UE and network can selectively establish one of two different communication sessions: a local breakout session and a non-local breakout session. In the non-local breakout session, the user traffic is routed across the operator s network. In the local breakout session, however, the user traffic is routed within the home network or to the Internet under the control of the HeNB, and thus does not influence the traffic load of the operator s network.

FIG. 1 is a diagram illustrating an Evolved Packet System (EPS) architecture based on a 3^{rd} Generation Partnership Project (3GPP) standards.

The EPS is a packet-optimized system evolved from the Universal Mobile Terrestrial System (UMTS). The EPS is also termed System Architecture Evolutions (SAE) and the terms are interchangeable used. The SAE system includes an Evolved-UMTS Terrestrial Radio Access Network (E-UTRAN) 103, an HeNB 104, a Mobility Management Entity (MME) 113, a Serving Gateway (S-GW) 105, a Policy Control and Charging Rules function (PCRF), and a Packet or Public Data Network (PDN) Gateway (PGW) 107.

The E-UTRAN 103 is an evolved access network and includes an evolved Node B (eNB).

The HeNB 104 is a femto base station which is deployed at a subscriber s home or small business and supports user access control in addition to the functions of normal eNB. The HeNB 104 also includes the partial functionalities of the PGW 107 and SGW 105 and supports local breakout function so as to route the local traffic within the home network other than to deliver to the SGW 105. That is, the HeNB 104 can route the data received through the E-UTRAN 103 within the home network by means of the internal SGW/PGW function 102.

The SGW/PGW function 102 is an internal gateway implemented in the HeNB 104 to support the data forwarding function as a base function of the SGW 105 and PGW 107. This function routing the data packet within the home network rather than transferring to the SGW 105 and PGW 107 is called as local breakout function.

The MME 113 is responsible for terminating Non Access Stratum (NAS) signaling, NAS signaling security, UE mobility management, idle mode UE management, roaming, authentication, and bearer management.

The SGW 105 is responsible for local mobility anchor function for inter-eNB handover, inter-Radio Access Technology (RAT) anchor function, idle mode downlink packet buffering function, and lawful interception (LI). Here, the LI means eavesdropping of IP with lawful authorization.

The PGW 107 is responsible for policy enforcement, per-user based packet filtering, charging support, LI, UE IP address allocation, and packet screening function.

The PCRF 111 is responsible for management of service-specific policy control and Quality of Service (QoS).

The SGSN 115 is an entity of the legacy packet network and responsible for controlling services related to the UEs. For instance, the SGSN 115 is responsible for manages the billing data per UE and provides the UE with the service-specific data.

The HSS 117 is responsible for managing the subscriber information and location information.

The above-described network entities can support additional functions depending on the supportable services.

FIG. 2 is a sequence diagram illustrating signaling among the network entities for allocating resources to the UE when a local data packet destined to the UE in idle mode is received by a HeNB in the conventional LTE system.

When there is no communication between the UE 101 and the HeNB 104 (or eNB) for predetermined time duration, the UE 101 releases all the resources and enters the idle mode. If a downlink (DL) data packet destined to the UE 101 in idle mode is received at the PGW 107 (201), the PGW forwards the DL data packet to the SGW 105. Upon receipt of the DL data packet, the SGW 105 checks whether the UE 101 is in idle mode or active mode. If the UE 101 is in idle mode, the SGW 105 buffers the DL data packet and sends a DL data notification message to the MME 113 to request for paging the UE 101 (203). If the DL data notification message is received, the MME 113 sends a Paging Request message to the eNB 104 (or HeNB) serving the UE 101 (205). Upon receipt of the Paging Request message, the HeNB 104 transmits a Paging message to the UE 101 (207). The UE 101 received the Paging message sends a Service Request message to the MME 113 via the HeNB 104 to request for resource allocation (209). Upon receipt of the Service Request message, the MME 113 checks the UE 101 context and sends the HeNB 104 an Initial Context Setup Request (ICSR) message for allocating radio resource corresponding to the EPS bearers available for the UE 101. The ICSR message includes the information related to the configuration of a radio bearer. Upon receipt of the ICSR message, the HeNB 104 establishes a radio bearer with the UE 101 (213). After the establishment of the radio bearer, the HeNB 104 sends an Initial Context Setup Complete message to the MME 113 (215). Upon receipt of the Initial Context Setup Complete message, the MME 113 sends an Update Bearer Request message to the SGW 105 for establishing a GTP tunnel between the SGW 105 and the eNB 104 (217). In response to the Update Bearer Request message, the SGW 105 sends an Update Bearer Response message (219).

### DISCLOSURE OF INVENTION

### Technical Problem

However, when the UE 101 transitions to the active mode to request the network for the radio resource, the UE 101 requests for the radio resource without consideration of whether the data packet to be received is the local breakout session packet and the non-local breakout session packet. This means that the UE 101 requests for the radio resource without differentiating the sessions from each other, thereby signaling to the SGW 105 and MME 113 unnecessarily when the data packet destined to the UE 101 is a local breakout session packet. For instance, when the data packet is received by means of the internal PGW of the HeNB 104, the HeNB 104 can route the data packet to the UE 101 directly without involvement of the macro PGW and SGW. However, the conventional resource allocation procedure delivers even the paging signal transmitted from the HeNB 104 to the UE 101 within the coverage of the HeNB 104 across the MME 113 and thus update bearer messages are transmitted to the SGW and PGW unnecessarily.

There is therefore a need to differentiate the local breakout session and non-local breakout session from each other and reduce unnecessary resource allocation and signaling among the network entities especially in the paging process for the local breakout session.

### Solution to Problem

In order to overcome the problems of the prior arts, the present invention provides a session-adaptive resource allocation method and device of a HeNB in EPS that is capable of reducing signaling traffic and propagation latency of data packet by differentiating the local breakout session from the non-local breakout session.

In accordance with an exemplary embodiment of the present invention, a resource allocation method for a wireless communication includes transmitting, at a Home evolved Node B (HeNB) received a downlink packet destined to a User Equipment (UE) in idle mode, a paging message including a local indicator to the UE; transmitting a service request message including the local indicator from the UE to a Mobility Management Entity (MME); transmitting a Initial Context Setup (ICS) message including an uplink Tunnel Endpoint Identifier (TEID) from the MME to the HeNB; and establishing a radio bearer for a local breakout session between the HeNB and UE and a radio bearer corresponding to an Evolved Packet System (EPS) bearer context of an internal Serving Gateway/Packet Data Network Gateway (SGW/PGW) of the HeNB using the TEID).

In accordance with another exemplary embodiment of the present invention, a wireless communication system includes a User Equipment (UE) which transmits, when receiving a paging message including a local indicator, a service request message including the local indicator to the system; a Home evolved Node B (HeNB) which includes an internal Serving Gateway/Packet Data Network Gateway (SGW/PGW), transmitting, when a data packet is received by means of the internal SGW/PGW, the paging message to the UE, establishes, when an Initial Context Setup (ICS) message is received, a radio bearer for a local breakout session, and establishes a radio bearer corresponding to an Evolved Packet System (EPS) bearer context of the internal SGW/PGW using a Tunnel Endpoint Identifier (TEID) contained in the ICS message; and a Mobility Management Entity (MME) which transmits, when the service request message including the local indicator is received from the UE, the ICS message including an uplink TEID to the HeNB.

### ADVANTAGEOUS EFFECTS OF INVENTION

The resource allocation device and method of the present invention is capable of allocating radio resources for the local breakout session and non-local breakout session independently, thereby avoiding unnecessary data traffic across the operator s network.

Also, the resource allocation device and method of the present invention is capable of routing the local breakout session data within the service area of the HeNB 104, thereby reducing signaling to the core network and propagation latency of the local breakout session data.

### BRIEF DESCRIPTION OF DRAWINGS

The above and other objects, features and advantages of the present invention will be more apparent from the following detailed description in conjunction with the accompanying drawings, in which:

FIG. 1 is a diagram illustrating an Evolved Packet System (EPS) architecture based on a 3^{rd} Generation Partnership Project (3GPP) standard;

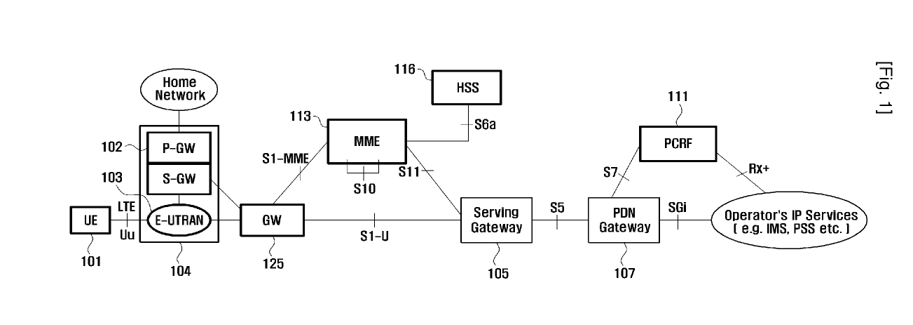

FIG. 2 is a sequence diagram illustrating signaling among the network entities for allocating resources to the UE when a local data packet destined to the UE in idle mode is received by a HeNB in the conventional LTE system;

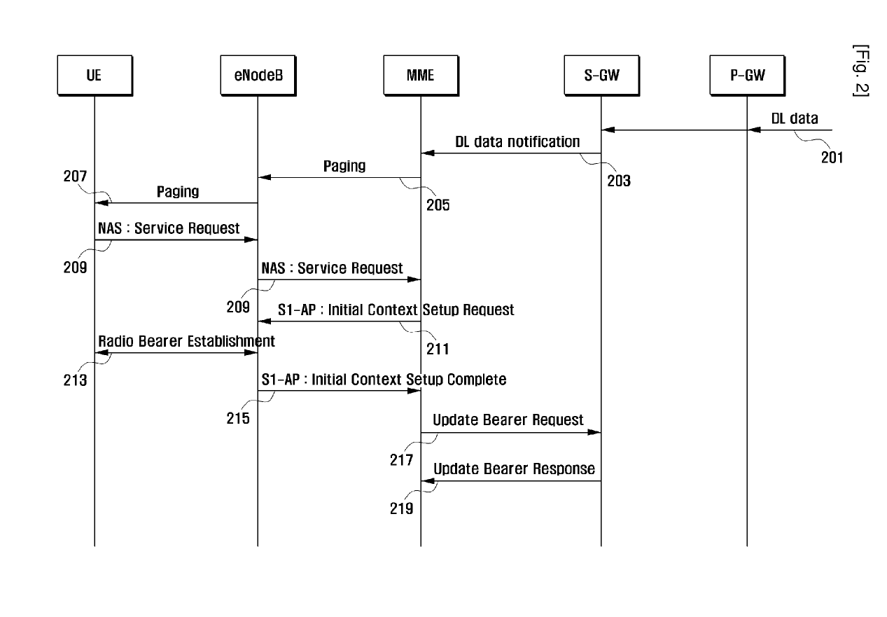

FIG. 3 is a sequence diagram illustrating signaling among the network entities for allocating a resource to a UE when a local data packet destined to the UE in idle mode is received by a HeNB of the LTE system in a resource allocation method according to an exemplary embodiment of the present invention;

FIG. 4 is a flowchart illustrating a session-adaptive resource allocation method in an LTE system according to an exemplary embodiment of the present invention; and

FIG. 5 is flowchart illustrating a session-adaptive resource allocation method in an LTE system according to another exemplary embodiment of the present invention.

### MODE FOR THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

The present invention proposes a method and system for controlling a HeNB in an LTE system. Particularly, the present invention proposes a session-adaptive resource allocation method and system for a HeNB in the LTE system supporting a local breakout service that the HeNB to differentiate the local breakout service from non-local breakout services and allocating the resource dedicated to a local breakout session for the local breakout service especially when the UE 101 transitions from the idle mode to the active mode.

In an exemplary embodiment of the present invention, the HeNB differentiates between the local IP addresses available within the home network under the control of the HeNB and the global IP addresses available for the operator s network. When an IP packet is received, the HeNB determines whether to route the IP packet within or across the operator s network based on the destination IP address of the IP packet and allocates radio resource depending on the determination. In case that a local data packet destined to a UE 101 is received, the HeNB pages the UE 101 directly with the indication of the local breakout session without signaling to the MME 113 such that the UE 101 requests for the radio resource dedicated to the local breakout session. If the resource allocation request for the local breakout session is received, the MME 113 sends the HeNB an Update Bearer Request message instructing resource allocation for the local breakout session.

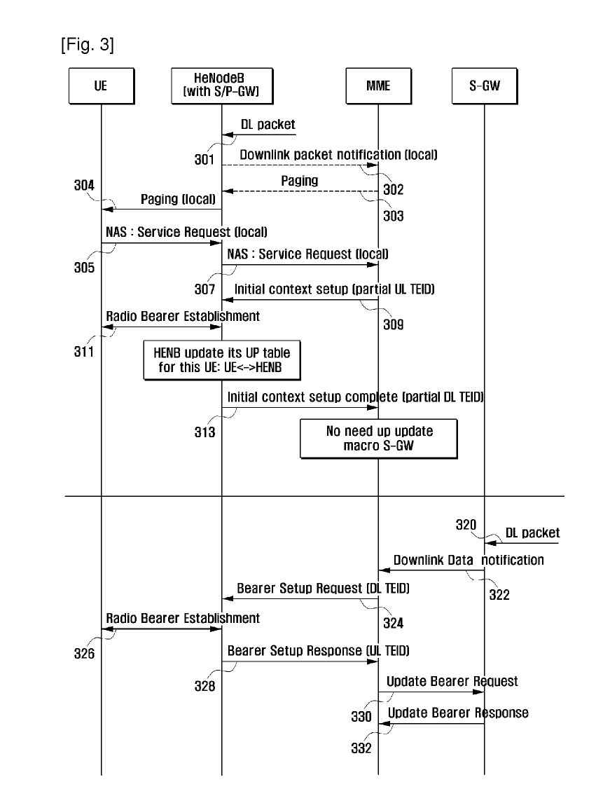

FIG. 3 is a sequence diagram illustrating signaling among the network entities for allocating a resource to the UE 101 when a local data packet destined to the UE 101 in idle mode is received by a HeNB 104 of the LTE system in a resource allocation method according to an exemplary embodiment of the present invention.

Referring to FIG. 3, a HeNB 104 including an internal SGW/PGW function block receives a downlink data packet destined to a UE 101 within the cellular radio coverage of the HeNB 104 (301). If the UE 101 is in idle mode and the data packet is received from a macro SGW 105, the HeNB 104 sends a Downlink Packet Notification message to the MME 113 (302) and receives a Paging message from the MME 113 in response to the Downlink Packet Notification message (303). Whereas, if the UE 101 in idle mode and the data packet is received from the internal SGW/PGW of the HeNB 104, this means the UE 101 to which the data packet is destined is within the service area of the HeNB 104 and thus the HeNB 104 sends a Paging message to the UE 101 directly (304) rather than transmitting a Service Request message to the MME 113 for paging all tracking areas. At this time, the Paging message includes a local indictor or a cause value for indicating that the paging is for the local breakout session. Upon receipt of the Paging message, the UE 101 sends a Service Request message including the local indicator to the HeNB 104 (305) and the HeNB 104 forwards the Service Request message to the MME 113 (307).

If the Service Request message is received, the MME 113 recognizes the request for the local breakout session based on the local indicator included in the Service Request message and sends an Initial Context Setup (ICS) message including a partial UL TEID to the HeNB 104 (309). Here, the ICS message contains only the information on the radio bearer available for the local breakout session of the HeNB 104 unlike the normal service request message containing the information about all the radio bearers stored in the UE 101 context managed by the MME 113. Upon receipt of the Initial Context Setup message, the HeNB 104 performs Radio Bearer Establishment with the UE 101 such that the UE 101 transitions to the active mode (311). At this time, the HeNB 104 matches the EPS bearer context of the SGW/PGW and the radio bearer using the TEIP contained in the Initial Context Setup message. That is, the data received over the radio bearer is delivered to the network connected to the HeNB 104 through the EPS bearer corresponding to the SGW/PGW function of the HeNB 104, and the data received through the SGW/PGW function of the HeNB 104 are transmitted to the UE 101 over the radio bearer. Once the radio bearer is established between the UE 101 and the HeNB 104, the HeNB 104 sends an Initial Context Setup Complete message to the MME 113 in response to the Initial Context Setup message (313). Since the radio bearer is connected to the internal SGW/PGW function of the HeNB 104, there is no need to inform the macro SGW 105 of the establishment of the radio bearer.

During the local breakout session, a downlink data packet can be received through the macro SGW 105 as denoted by reference numeral 320.

If a downlink data packet destined to the UE 101 operating in active mode (320), the macro SGW 105 sends a Downlink Data Notification message to the MME 113 to inform of the receipt of downlink data packet (322). Upon receipt of the Downlink Data Notification message, the MME 113 sends a Bearer Setup Request message including a DL TEID to the HeNB 104 to create a radio bearer requested by the macro SGW 105 (324) rather than transmitting the Paging Request message, since the MME 113 knows the UE 101 is operating in active mode. Upon receipt of the Bearer Setup Request message, the HeNB 104 performs a Radio Bearer Establishment procedure with the UE 101 (326) and sends a Bearer Setup Response message to the MME 113 to indicate the completion of the radio bearer establishment (328). Upon receipt of the Bearer Setup Response message, the MME 113 sends an Update Bearer Request message to the macro SGW 105 (330) and receives an Update Bearer Response message from the macro SGW 105 in response to the Update Bearer Request message (340). As a consequence a GTP tunnel is established between the HeNB 104 and the macro SGW 105.

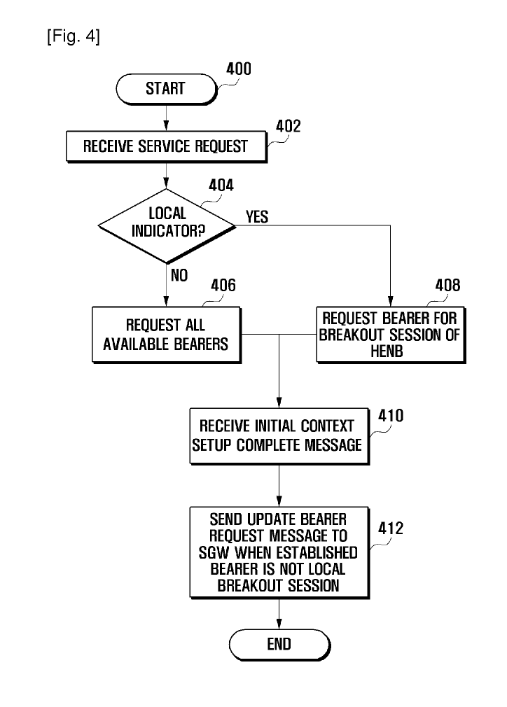

FIG. 4 is a flowchart illustrating a session-adaptive resource allocation method in an LTE system according to an exemplary embodiment of the present invention.

Referring to FIG. 4, the MME 113 of the LTE system receives a Service Request message transmitted by the UE 101 (402). Once a Service Request message is received, the MME 113 determines whether the Service Request message includes a local indicator (404). If the Service Request message includes a local indicator, the MME 113 sends the HeNB 104 an Initial Context Setup (ICS) message indicative of a local breakout session (408). Otherwise, if the Service Request message does not includes a local indicator, the MME 113 sends the HeNB 104 an Initial Context Setup (ICS) message indicative of a non-local breakout session (406).

In response to the Initial Context Setup message, the MME 113 receives an Initial Context Setup Complete message indicative of radio bearer establishment (410). Once the Initial Context Setup Complete message is received, the MME 113 performs a Bearer Update process depending on the information contained in the Initial Context Setup Complete message (412). In more detail, if the Initial Context Setup Complete message indicates the radio bearer establishment of the local breakout session, the MME 113 does not send a Bearer Update Request message to the SGW 105. Otherwise, if the Initial Context Setup Complete message indicates the radio bearer establishment of the non-local breakout session, the MME 113 sends a Bearer Update Request message to the SGW 105.

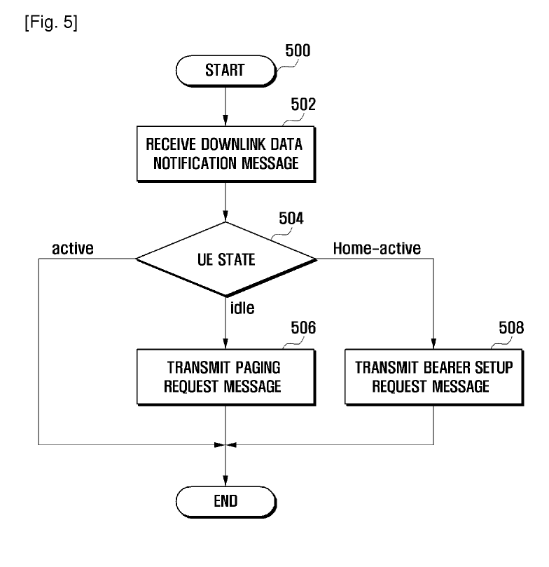

FIG. 5 is flowchart illustrating a session-adaptive resource allocation method in an LTE system according to another exemplary embodiment of the present invention.

Referring to FIG. 5, the MME 113 first receives a Downlink Data Notification message (502). If a Downlink Data Notification message is received, the MME 113 determines whether the target UE 101 is in active mode or idle mode (504). If the UE 101 is in idle mode, the MME 113 sends a Paging Request message to the HeNB 104 (506). Otherwise, if the UE 101 in active mode, the MME 113 sends the HeNB 104 a Bearer Setup Request message indicating addition of radio bearers corresponding to the EPS bearers except for that of local breakout session (508).

As described above, the resource allocation device and method of the present invention is capable of allocating radio resources for the local breakout session and non-local breakout session independently, thereby avoiding unnecessary data traffic across the operator s network.

Also, the resource allocation device and method of the present invention is capable of routing the local breakout session data within the service area of the HeNB 104, thereby reducing signaling to the core network and propagation latency of the local breakout session data.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A resource allocation method for a wireless communication, comprising:
transmitting, at a Home evolved Node B (HeNB) received a downlink packet destined to a User Equipment (UE) in idle mode, a paging message including a local indicator to the UE;
transmitting a service request message including the local indicator from the UE to a Mobility Management Entity (MME);
transmitting a Initial Context Setup (ICS) message including an uplink Tunnel Endpoint Identifier (TEID) from the MME to the HeNB; and
establishing a radio bearer for a local breakout session between the HeNB and UE and a radio bearer corresponding to an Evolved Packet System (EPS) bearer context of an internal Serving Gateway/Packet Data Network Gateway (SGW/PGW) of the HeNB using the TEID.

2. The resource allocation method of claim 1, further comprising transmitting, at the HeNB, data received by the internal SGW/PGW to the UE through the radio bearer, and transmitting the data received through the radio bearer to a network through an EPS bearer of the internal SGW/PGW.

3. The resource allocation method of claim 2, further comprising paging, at the HeNB, the UE when the internal SGW/PGW of the HeNB receives the data destined to the UE.

4. The resource allocation method of claim 3, wherein the ICS message comprises information on a radio bearer dedicated to the local breakout session of the HeNB.

5. The resource allocation method of claim 4, further comprising skipping, when the MME receives the ICS complete message including a downlink TEID from the HeNB, notification of the radio bearer establishment to a macro SGW.

6. The resource allocation method of claim 5, further comprising:
transmitting, when the MME receives a downlink data notification message from the macro SGW, a bearer setup request message from the MME to the HeNB;
performing, when the HeNB receives the bearer setup request message, a radio bearer establishment between the HeNB and UE and transmitting a bearer setup response message from the HeNB to the MME; and
establishing a tunnel between the HeNB and macro SGW by transmitting an update bearer request message from the MME to the macro SGW.

7. A wireless communication system comprising:
a User Equipment (UE) which transmits, when receiving a paging message including a local indicator, a service request message including the local indicator to the system;
a Home evolved Node B (HeNB) which includes an internal Serving Gateway/Packet Data Network Gateway (SGW/PGW), transmitting, when a data packet is received by means of the internal SGW/PGW, the paging message to the UE, establishes, when an Initial Context Setup (ICS) message is received, a radio bearer for a local breakout session, and establishes a radio bearer corresponding to an Evolved Packet System (EPS) bearer context of the internal SGW/PGW using a Tunnel Endpoint Identifier (TEID) contained in the ICS message; and
a Mobility Management Entity (MME) which transmits, when the service request message including the local indicator is received from the UE, the ICS message including an uplink TEID to the HeNB.
